(19) United States
(12) Patent Application Publication
(10) Pub. No.: US 2015/0317956 A1
(43) Pub. Date: Nov. 5, 2015

(54) HEAD MOUNTED DISPLAY UTILIZING COMPRESSED IMAGERY IN THE VISUAL PERIPHERY

(71) Applicant: INTERNATIONAL BUSINESS MACHINES CORPORATION, Armonk, NY (US)

(72) Inventors: David B. Lection, Raleigh, NC (US); Eric L. Masselle, Raleigh, NC (US)

(73) Assignee: INTERNATIONAL BUSINESS MACHINES CORPORATION, Armonk, NY (US)

(21) Appl. No.: 14/265,545

(22) Filed: Apr. 30, 2014

(51) Int. Cl. G09G 5/38; G02B 27/00; G02B 27/01; G06T 19/00; G09G 5/36

(52) U.S. Cl. CPC G09G 5/38; G06T 19/006; G09G 5/363; G02B 27/017; G02B 27/0093; G02B 2027/0178

(57) ABSTRACT

A system, method and wearable display unit for presenting content to a user is disclosed. A display is worn by a user in front of eyes of the user. The display includes a peripheral display area for displaying content to the user in at least one peripheral visual area of the user. A processor provides content to the peripheral display area. A database may store content and the processor obtains the content from the database. The database may be separate from the wearable display unit. A camera of the wearable display unit may also provide the content.

### BACKGROUND

The present invention relates to a method and apparatus for presenting content visually, and more specifically, to a wearable display for presenting images or content in a peripheral region of a user's visual field.

Heads-up, wearable displays are becoming increasingly in use. These displays allow a user to wear a display portion of a computer in front of the user's eyes in the manner of eyeglasses. The display portion is a transparent or semi-transparent display. The user is thus able to view content presented to the user's eyes at the display, as well as to see through the display to the world beyond the display. Typically, these wearable displays include small display areas that are located in the foveal or paraxial view of the user so that the viewer views the content on the display by looking straight ahead.

### SUMMARY

According to one embodiment of the present invention, a wearable display unit includes a display configured to be worn by a user in front of eyes of the user, wherein the display includes a peripheral display area for displaying content to the user in at least one peripheral visual area of the user and a processor configured to provide content to the peripheral display area.

According to another embodiment of the present invention, a method of viewing content includes: wearing a wearable display unit on a head of a user that includes a display in front of eyes of the user; and providing, using a processor, the content for viewing in a peripheral display area of the display device.

According to another embodiment of the present invention, a system for providing content to a user includes: a display configured to be worn by a user in front of eyes of the user, wherein the display includes a peripheral display area for displaying content to the user in at least one peripheral visual area of the user; a database having the content stored therein; and a processor configured to obtain content from the database and display the content at the peripheral display area.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 shows an illustrative wearable display unit of the present disclosure;

FIG. 2 shows a top view of the display illustrating various regions of the illustrative wearable display unit;

FIG. 3 shows a detailed view of the left earpiece of the wearable display unit in one embodiment of the invention;

FIG. 4 illustrates use of the wearable display unit by a user in a selected environment; and

FIG. 5 illustrates an exemplary visual display that may be seen by the user of FIG. 4.

### DETAILED DESCRIPTION

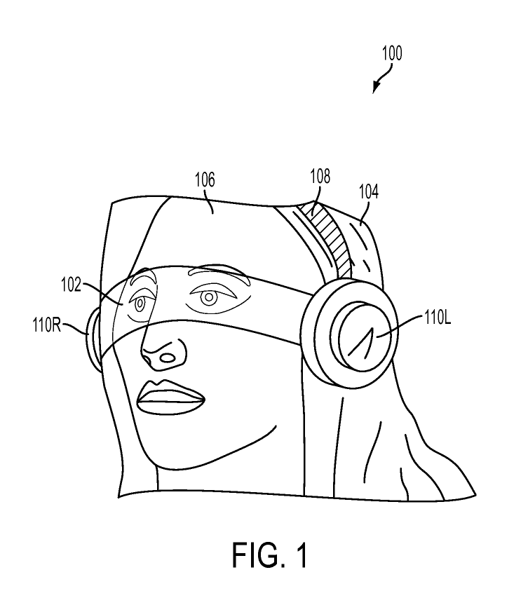

Embodiments of the present invention disclose an apparatus and methods for displaying data, content and/or images in a peripheral display area of a wearable display unit 100 (see FIG. 1). The wearable display unit 100 includes a display 102 that extends across a viewing angle of a user wearing the wearable display unit 100. The wearable display unit 100 may further include side and/or rear-facing cameras that obtain images to the side of the user or behind the user. The images may then be supplied to the display to be presented in a peripheral visual area of the user. Also, images or content may be displayed at a paraxial visual area of the user. The wearable display unit 100 may further include a camera and/or a processor that communicates with an outside network and/or a separate camera to provide additional data to the peripheral visual area of the user. Current heads-up display devices provide content to the user when the user looks straight ahead, without regard to, or without considering, the user's peripheral vision. The present invention therefore addresses the user's peripheral vision and presents content to the user's peripheral visual area in a suitable manner so that the user may be aware of such content and use such content.

FIG. 1 shows an illustrative wearable display unit 100 of the present disclosure. The wearable display unit 100 generally includes a display 102 and a support structure 104 for mounting the display on a head of a user 106. The support structure 104 may be adjustable so that the display 102 may be located in front of the eyes of the user 106, generally within about an inch of the user's eyes, when the wearable display unit 100 is being worn. The support structure 104 may include at least one earpiece 110L, 110R that may rest on the ears of the user 106. In various embodiments, one or more of the earpieces 110L and 11OR include a temple of the wearable display unit 100 or, in other words, a portion that extends from the user's ears to the display 102. Additionally, the support structure 104 may include a band 108 that crosses over the head of the user 106 or behind the head of the user 106 to support the wearable display unit 100 on the head of the user 106. The display 102 extends across a viewing area of the user 106. The display 102 may be made of a transparent or semi-transparent material so that the user 106 is able to see through the display 102 to the world beyond the display 102. The display 102 further comprises an embedded or attached array of LEDs or other light-producing devices for presenting an image, content or data at the display 102. The embedded or attached array may be controlled by a processor (FIG. 3, 302) to display data, content or images to the user 106. Thus, the user 106 may be able to view the world beyond the display 102 as well as an image, content or data presented at the display 102.

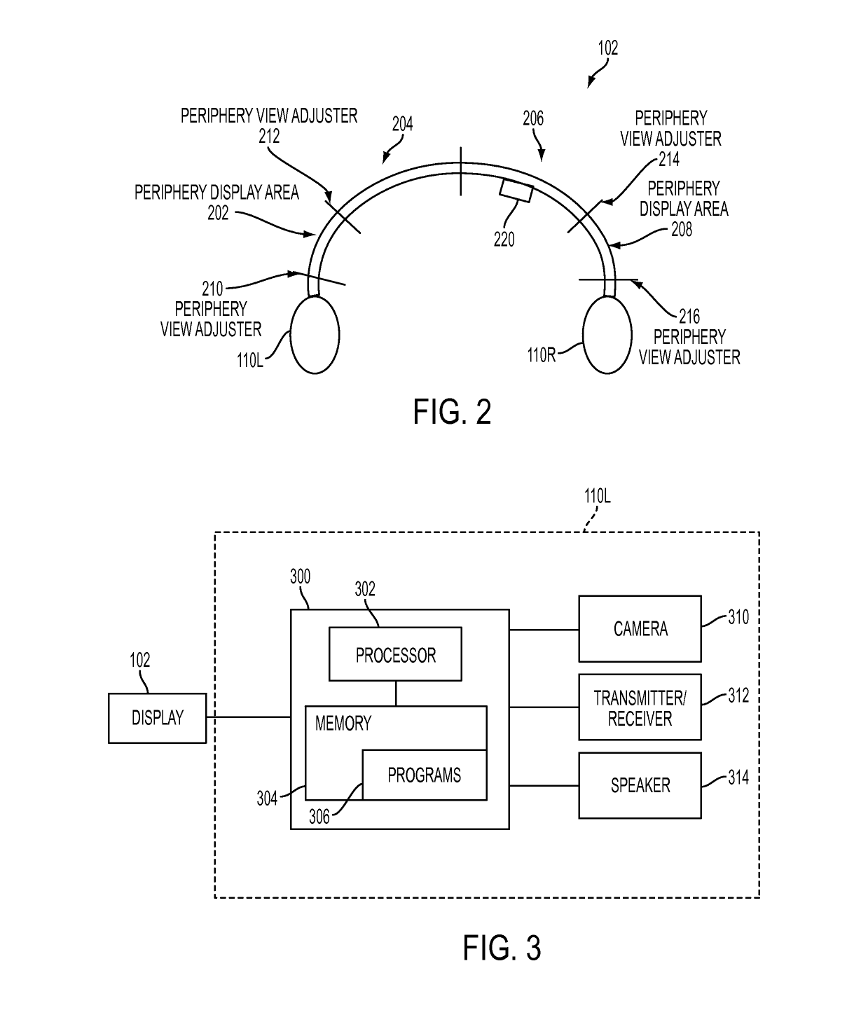

FIG. 2 shows a top view of the display 102 illustrating various regions of the illustrative wearable display unit 100. The display 102 includes various display areas 202, 204, 206 and 208. Display areas 204 and 206 are front display areas. The user generally directs his/her eyes through these front display areas 204 and 206. Left peripheral display area 202 and right peripheral display area 208 are located at the left peripheral visual area and right peripheral visual area, respectively, of the user 106. Data and/or images may be displayed in any of the display areas 202, 204, 206 and 208. The display 102 further includes left periphery view adjusters 210 and 212 that may be used to adjust a width or dimension of the left peripheral display area 202 and right periphery view adjusters 214 and 216 that may be used to adjust a width or dimension of the right peripheral display area 208. The left peripheral display area 202 is bounded by the left periphery view adjusters 210 and 212. The right peripheral display area 208 is bounded by the right periphery view adjusters 214 and 216. In one embodiment, the periphery view adjusters 210, 212, 214 and 216 may be physical components of the display 102 that may move or slide along the display 102. The user 106 may then move a selected periphery view adjuster 210, 212, 214, 216 by contacting the selected periphery display adjuster 210, 212, 214, 216 with an object, such as his or her finger, and sliding the selected periphery view adjuster 210, 212, 214, 216 to a selected or desired location. In another embodiment, the periphery view adjusters 210, 212, 214 and 216 may exist as coordinate locations stored in a memory storage device (FIG. 3, 304). A selected touch pattern to the screen, such as a touch for an extended period of time, a swipe, etc., may indicate that the user 106 intends to adjust a display area. The user 106 may then move his or her finger to a selected or desired location and release the finger from the display 102. The processor (FIG. 3, 302) may track a location or coordinate of the finger at the display and record a coordinate at which the finger is released from the display 102 to determine a dimension for the selected peripheral display area 202, 208. Left and right peripheral display areas 202 and 208 may be adjusted independently of each other. In another embodiment, an eye-movement detector 220 may read a glance or eye movement of the user 106 and change the dimension of a selected peripheral display area 202, 208 based on the eye movement. In addition, selected finger motions or eye movements may be used to adjust other parameters of the display, such as resolution of the peripheral display areas, etc.

FIG. 3 shows a detailed view of the left earpiece 110L of the wearable display unit 100 in one embodiment of the invention. The left earpiece 110L may include circuitry for controlling the wearable display unit 100. Left earpiece 110L is shown for illustrative purposes only, and the right earpiece 11OR may include the circuitry for controlling the wearable display unit 100 in alternate embodiments. The circuitry may be concentrated at the ear of the user or may be disposed along a length of the temple between the ear and the display 102. The exemplary earpiece 110L may include a controller 300 that provides the data content and/or images to the various display areas 202, 204, 206 and 208. The controller 300 may include a processor 302 and a memory storage device 304 accessible to the processor 302. Programs 306 stored at the memory storage device 304 may be accessed by the processor 302 to enable the processor 302 to perform the various operations of the display 102, such as displaying images and/or data at the display areas 202, 204, 206 and 208, changing the dimensions and resolution of the display areas 202, 204, 206 and 208, etc. The controller 300 may further be in communication with a transmitter/receiver 312, which may include a transmitter, a receiver, or both a transmitter and receiver. In one embodiment, the transmitter/receiver 312 receives content from a database separate from the wearable display unit 100 and provides the received content to the processor 302, which may present the received content at at least one of the display areas 202, 204, 206 and 208.

The exemplary left earpiece 110L may further include at least one camera 310 in communication with the controller 300. The at least one camera 310 may provide a visual image to the processor 302 which may then present the visual image to the user at one of the left peripheral display area 202 and the right peripheral display area 208. The at least one camera 310 may be oriented towards a rear side of the user 106 or to a left or right side of the user 106. In one embodiment, a camera located at the left earpiece 110L may provide an image in a field of view at a back-left side of the user 106 to the left peripheral display area 202 and a camera located at the right earpiece 11OR may provide an image at a back-right side of the user 106 to the right peripheral display area 208. Thus, the user may be provided with a 360 degree visual range through the display areas 202, 204, 206 and 208. The at least one camera 310 may include a wide-angle lens, and the image provided from the at least one camera 310 may be compressed in size or along a selected dimension when presented at the peripheral display areas 202, 208. The left earpiece 110L may further include a speaker 314 that may provide audio signals for the user 106.

The image compression allows an image or images from a wide angle camera or multiple cameras to be combined into a single image and compressed along the horizontal dimension or horizontal axis. Therefore, the original image can be fit into a normal peripheral range of the viewer. As an illustrative example, the at least one camera 310 may capture 100 horizontal degrees of visual image. This image may be compressed horizontally so as to fit into a 40 degree range of a peripheral field of vision of the viewer, thereby increasing the viewer's peripheral field of vision by 150%. The compression takes advantage of the fact that peripheral vision senses movement primarily. This movement is not deteriorated by the horizontal compression.

The processor 302 may be further in communication via the transmitter/receiver 312 with a router or other network communication device that may be used to establish a communication link with a network such as a WAN, LAN, Internet, etc. Thus, the processor 302 may be able to receive content from the network and display the received content at the any of the display areas 202, 204, 206, 208. The received content may be displayed as data, as an image or as a symbolic representation. For example, a color may be selected to indicate a threat level of a given content. A red color may be used to indicate that content in the peripheral view is dangerous and a green or blue image may be used to indicate that the content is benign or friendly. While the left earpiece 110L is shown to include the various circuitry for illustrative purposes, this circuitry may alternatively reside in the right earpiece 11OR or the circuitry may be divided between left and right earpieces 110L, 11OR so that, for example, the at least one camera 310 is in right earpiece 11OR and the transmitter/receiver 312 is in left earpiece 110L, etc.

The peripheral display areas 202, 208 may also be used to display additional or alternative content to the user. Since the periphery of the retina is good at detecting movement, the processor 302 may enhance or exaggerate movement in the peripheral display areas 202, 208, thereby allowing the user 106 to become hyper-aware of moving objects ordinarily outside of the user's field of view. Since the periphery of the retina is very poor at detecting color, the processor 302 may exaggerate the colors of objects in the left and/or right peripheral display areas 202, 208 in order to improve color-detection in the peripheral visual areas of the user 106. The left and right peripheral display areas 202, 208 may also be made to become opaque under certain circumstances. This opacity may be brought on manually, in response to a verbal command, a touch or another user input. Alternatively, the opacity may be brought on automatically. For example, if a user is walking immediately next to a building, the peripheral display area on that side of the user 106 may become automatically opaque in order to reduce distractions. Also, if the eye movement detector 220 detects that the user is squinting, both peripheral display areas 202, 208 may be made opaque to allow the user to focus more completely on his or her frontal view.

Images in the peripheral visual area of the user 106 may be further enhanced by reducing an amount of distracting imagery being displayed. If the display only shows objects moving in a single direction (i.e., not swaying back and forth, for instance), and blocks all other components of the image, replacing them with a high-contrast background, the significant objects will stand out in stark relief to the background, while reducing the amount of distracting information the eye processes. These methods may also be used to display sufficiently large and highly-colored visual signals to the user at locations close to the front of the peripheral display area (i.e., near the front display areas 204, 206) where color detection is less compromised.

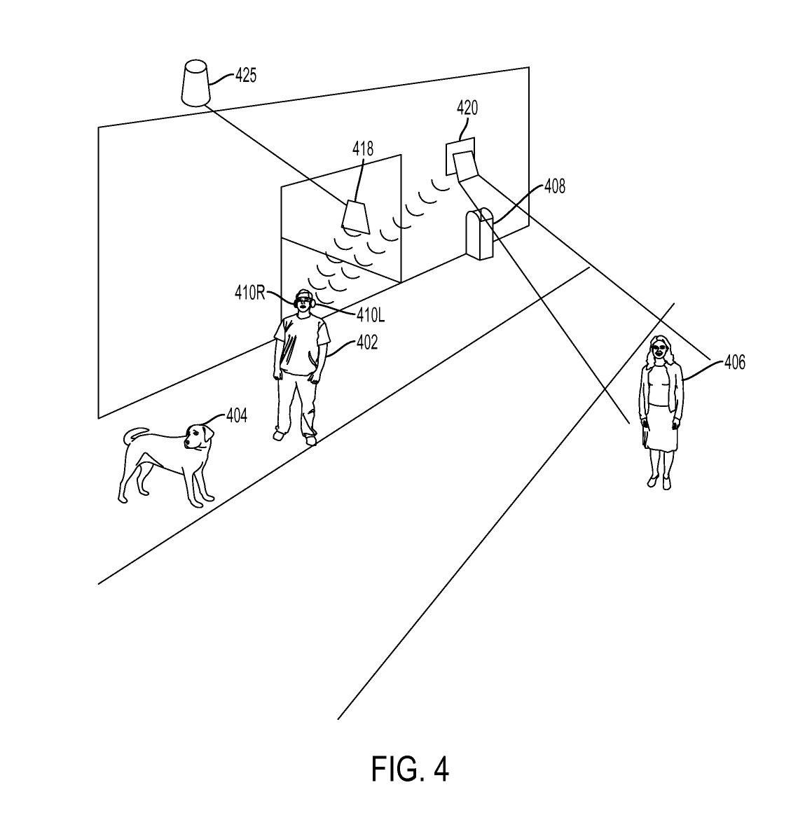

FIG. 4 illustrates use of the wearable display unit 100 on a user in a selected environment. The user 402 is facing a dog 404. Behind the user 402 and across the street on the left-hand side of the user 402 is a woman 406. Behind the user 402 and on the right-hand side of the user 402 is a mailbox 408. The mailbox 408 is located in the field of view of a rear-facing camera of the right earpiece 410R. The left earpiece 410L is in communication with a surveillance camera 420 and receives image signals from the surveillance camera 420. The woman 406 is in the field of view of the surveillance camera 420.

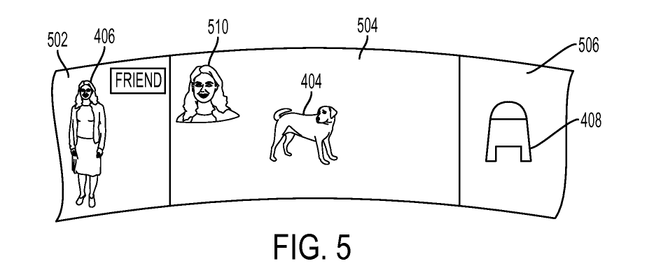

FIG. 5 illustrates an exemplary visual display that may be seen by the user 402 described in FIG. 4. The dog 404 appears in the front display area 504. The woman 406 is shown at the left peripheral display area 502. The mailbox 408 is shown in the right peripheral display area 506.

In one example, when one of the user's Facebook friends (e.g., the woman 406) approaches from behind or is captured in a peripheral display area 202, 208, the user may detect the person approaching, but—because of the peripheral retina's poor shape detection—will be unable to identify the person. However, a detection system at a computer or database 425 (connected to the processor 302 via transmitter/receiver 312 and router 418) may be used to determine the identity of the user (e.g., Facebook friend) and display a non-threatening color (e.g., blue) with respect to the woman 406. Additionally, upon identifying the woman 406, her face 510 may be enlarged and displayed at the front display areas 204, 206 so that the user 402 may employ the retina's center receptors to be able to recognize the woman 406. In another example, rather than a friend, an attacker is approaching the user with a weapon. The processor 302 may access the detection system to identify the attacker as dangerous and immediately flash a red warning signal in the user's left periphery display area 502. A weapon hand of the attacker may be enlarged and displayed at the frontal display area 504 to allow the user to more clearly see the nature of the threat. The processor 302 may then prompt the user 402 to determine if a police call is necessary. In another embodiment, the processor 302 may initiate a call to the police automatically based on a determined threat level of the displayed content. Video from the wearable display unit 100 may also be forwarded to the police along with the call.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A wearable display unit, comprising:
a display configured to be worn by a user in front of eyes of the user, wherein the display includes a peripheral display area for displaying content to the user in at least one peripheral visual area of the user; and
a processor configured to provide content to the peripheral display area.

2. The wearable display unit of claim 1, further comprising a receiver coupled to the processor, the receiver configured to receive content from a network, wherein the processor presents the received content in the peripheral display area.

3. The wearable display unit of claim 1, further comprising a camera for obtaining image content for presentation at the peripheral display area.

4. The wearable display unit of claim 3, wherein the camera further comprises at least one of: (i) a camera of the wearable display unit oriented towards a back of the user; (ii) a camera of the wearable display unit oriented towards a side of the user; and (iii) a camera physically separate from the wearable display and in communication with the processor.

5. The wearable display unit of claim 1, further comprising a peripheral display area adjuster configured to adjust a dimension of the peripheral display area.

6. The wearable display unit of claim 1, wherein the processor is further configured to provide at least one of: (i) image enhancement; (ii) color coding; and (iii) image recognition to the content displayed in the peripheral display area.

7. The wearable display unit of claim 1, further comprising an eye-movement detector configured to adjust a parameter of the wearable display unit based on a selected eye movement of the user.

8. The wearable display unit of claim 1, wherein the processor is further configured to initiate a call based on a determined threat level of the content.

9. A method of viewing content, comprising:
wearing a wearable display unit on a user that includes a display in front of eyes of the user; and
providing, using a processor, the content for viewing in a peripheral display area of the display device.

10. The method of claim 9, further comprising receiving the content from a network at a receiver coupled to the processor and presenting the received content in the peripheral display area.

11. The method of claim 9, obtaining the content from a camera and presenting the received content at the peripheral display area of the display.

12. The method of claim 11, wherein the camera further comprises at least one of: (i) a camera of the wearable display unit oriented towards a back of the user; (ii) a camera of the wearable display unit oriented towards a side of the user; and (iii) a camera physically separate from the wearable display and in communication with the processor.

13. The method of claim 11, further comprising compressing an image from the camera along horizontal axis.

14. The method of claim 9, further comprising adjusting a display dimension of the peripheral display area.

15. The method of claim 9, further comprising providing at least one of: (i) image enhancement; (ii) color coding; and (iii) image recognition to the content displayed in the peripheral display area.

16. The method of claim 9, further comprising determining an eye movement of the user using an eye movement detector of the wearable display unit and adjusting a parameter of the peripheral display area based on the determined eye movement of the user.

17. A system for providing content to a user, comprising:
a display configured to be worn by a user in front of eyes of the user, wherein the display includes a peripheral display area for displaying content to the user in at least one peripheral visual area of the user;
a database having the content stored therein; and
a processor configured to obtain content from the database and display the content at the peripheral display area.

18. The system of claim 17, further comprising a transmitter and a receiver coupled to the processor, the transmitter configured to transmit a request for content to the database and the receiver configured to receive content from the database.

19. The system of claim 17, further comprising a camera configured to obtain image content for presentation at the peripheral display area.

20. The system of claim 1, wherein the processor is further configured to provide at least one of: (i) image enhancement; (ii) color coding; and (iii) image recognition to the content displayed in the peripheral display area.
